(19) United States
(12) Patent Application Publication
(10) Pub. No.: US 2026/0042331 A1
(43) Pub. Date: Feb. 12, 2026

(54) GOLF VEHICLE ACCESSORY

(71) Applicant: Textron Inc., Providence, RI (US)

(72) Inventors: John Michael Schonewolf, Augusta, GA (US); Karan Shenoy Yelthimar, Bangalore (IN); Rohith Rohidas Pai, Bangalore (IN)

(73) Assignee: Textron Inc., Providence, RI (US)

(21) Appl. No.: 18/926,886

(22) Filed: Oct. 25, 2024

(30) Foreign Application Priority Data
Aug. 9, 2024 (IN) 202441060298

(51) Int. Cl. B60H 1/00

(52) U.S. Cl. CPC B60H 1/00264; B60H 1/00285; B60H 1/00407

(57) ABSTRACT

A cooling assembly for a vehicle includes a housing defining a first opening and a housing volume configured to receive a coolant, a heat exchanger, a fan proximate the heat exchanger, a pump positioned within the housing volume, and a sensor configured to detect a presence of an operator. The fan is configured to selectively provide air through the heat exchanger and out the opening to facilitate providing a cooled airflow to the operator of the vehicle. The pump is fluidly coupled to the heat exchanger. The pump is configured to selectively provide the coolant to the heat exchanger. The sensor provides a signal when the presence of the operator is detected that causes the fan and the pump to operate.

### CROSS-REFERENCE TO RELATED APPLICATIONS

This application claims Paris Convention priority to Indian Patent Application No 202441060298 filed on Aug. 9, 2024. The entire content of the aforementioned application is incorporated herein by reference.

### BACKGROUND

Golf vehicles are used to transport personnel and equipment between different areas. By way of example, a golf vehicle may transport golfers and equipment (e.g., golf bags, golf clubs, etc.) around a golf course (e.g., along a cart path, between different holes, etc.). It may be desirable to improve the comfort of operators and/or passengers of the golf vehicle, while maintaining the ability of the golf vehicle to store equipment.

### SUMMARY

One embodiment relates to a golf vehicle. The golf vehicle includes a frame, a seat coupled to the frame and configured to support an operator, a cooling assembly, and a sensor. The cooling assembly includes a housing defining a housing volume configured to receive a coolant, a heat exchanger, a fan proximate the heat exchanger, and a pump positioned within the housing volume. The fan is configured to selectively provide air through the heat exchanger to facilitate providing a cooled airflow to the operator. The fan is operable between a first fan state and a second fan state. The pump is fluidly coupled to the heat exchanger. The pump is configured to selectively provide the coolant to the first heat exchanger. The pump is operable between a first pump state and a second pump state. The sensor is coupled to the cooling assembly. The sensor is configured to detect a presence of the operator. The sensor provides a first signal when the presence of the operator is not detected that causes the fan to operate at the first fan state and the pump to operate at the first pump state. The sensor provides a second signal when the presence of the operator is detected that causes the fan to operate at the second fan state and the pump to operate at the second pump state.

Another embodiment relates to a cooling assembly for a vehicle. The cooling assembly includes a housing defining a first opening and a housing volume configured to receive a coolant, a heat exchanger, a fan proximate the heat exchanger, a pump positioned within the housing volume, and a sensor configured to detect a presence of an operator. The fan is configured to selectively provide air through the heat exchanger and out the opening to facilitate providing a cooled airflow to the operator of the vehicle. The pump is fluidly coupled to the heat exchanger. The pump is configured to selectively provide the coolant to the heat exchanger. The sensor provides a signal when the presence of the operator is detected that causes the fan and the pump to operate.

Still another embodiment relates to a golf vehicle. The golf vehicle includes a frame, a seat coupled to the frame and configured to support an operator, a sensor configured to detect a presence of the operator, an accessory storage area positioned proximate the seat, and a golf vehicle accessory. The golf vehicle accessory includes an upper housing portion, a lower housing portion defining a housing volume configured to receive a coolant where the lower housing portion positioned least partially within the accessory storage area, a heat exchanger positioned within the upper housing portion, a fan proximate the heat exchanger, and a pump positioned within the housing volume. The fan is configured to selectively provide air through the heat exchanger to facilitate providing a cooled air flow to the operator. The pump is fluidly coupled to the heat exchanger. The pump is configured to selectively provide the coolant to the heat exchanger. The sensor provides a signal when the presence of the operator is detected that causes the fan and the pump to operate.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a golf vehicle accessory, according to an exemplary embodiment.

FIG. 4 is a rear perspective view showing a portion of a vehicle including an accessory shown in a first configuration, according to an exemplary embodiment.

FIG. 5 is front perspective view showing a portion of the vehicle of FIG. 4, according to an exemplary embodiment.

FIG. 6 is a side view showing a portion of the vehicle of FIG. 4, according to an exemplary embodiment.

FIG. 7 is a right perspective view of an accessory usable in a vehicle, according to an exemplary embodiment.

FIG. 8 is a left perspective view of the accessory of FIG. 7, according to an exemplary embodiment.

FIG. 9 is a front perspective view of the accessory of FIG. 7, according to an exemplary embodiment.

FIG. 10 is a front perspective view of a vehicle including an accessory shown in a second configuration, according to an exemplary embodiment.

FIG. 11 is a rear perspective view showing a portion of a vehicle including an accessory shown in a third configuration, according to an exemplary embodiment.

FIG. 12 is a perspective view showing a portion of a vehicle including an accessory shown in a fourth configuration, according to an exemplary embodiment.

FIG. 13 is a rear perspective view of a vehicle including an accessory shown in a fifth configuration, according to an exemplary embodiment.

FIG. 14 is a rear perspective view of a vehicle including an accessory shown in a sixth configuration, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

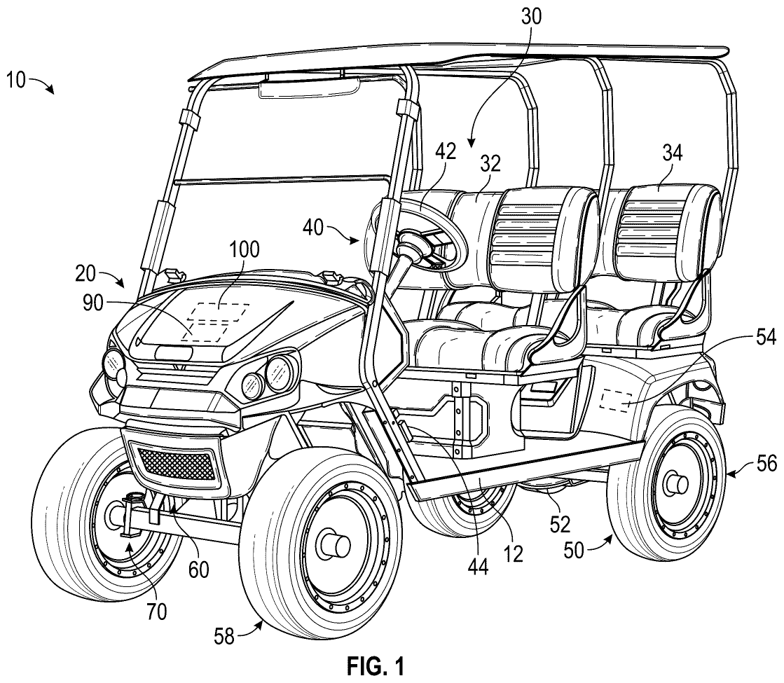

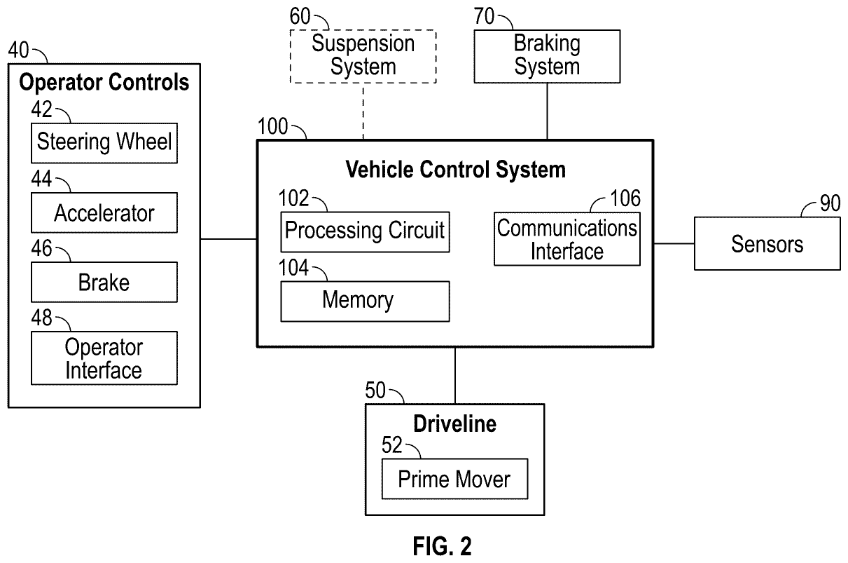

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, a hauler, an all-terrain vehicle (“ATV”), a utility task vehicle (“UTV”), a low speed vehicle (“LSV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories. In some embodiments, the occupant seating area 30 is fully enclosed (e.g., a hauler).

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system.

In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Vehicle Structure

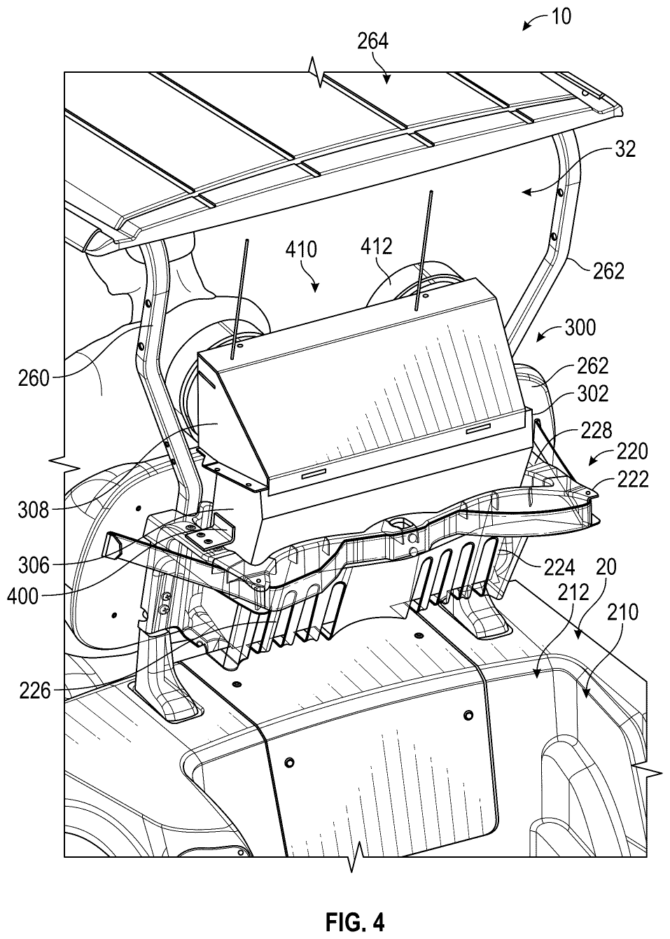

Referring to FIG. 4-6 and 10-14, the vehicle 10 is shown according to various exemplary embodiments. The vehicle 10 of FIG. 4-6 and 10-14 may be substantially similar to the vehicle 10 of FIG. 1 except as otherwise specified herein. In some embodiments, the vehicle 10 is configured as a golf vehicle.

As shown in FIG. 4-6 and 11-14, the vehicle 10 includes the front row seating 32, and the rear row seating 34 is omitted. In other embodiments, the vehicle 10 includes at least the front row seating 32, and the rear row seating 34 is optionally included. In any of the embodiments shown, the front row seating 32 extends laterally across the body 20, from a right side of the body 20 (e.g., a first lateral side) to a left side of the body 20 (e.g., a second lateral side). Accordingly, the front row seating 32 may provide at least two seats (e.g., for an operator or driver and one or more passengers). The front row seating 32 includes a first seat portion, shown as seat bottom 200, and a second set portion, shown as seat back 202. The seat bottom 200 extends substantially horizontally and supports the bottom of the occupant. The seat back 202 extends substantially vertically and supports the back of the occupant.

As shown in FIG. 4-6 and 11-14, the vehicle 10 includes a first storage area (e.g., for storing golf equipment), shown as equipment storage area 210. According to the exemplary embodiment shown in FIG. 4-6 and 11-14, the equipment storage area 210 is positioned rearward of the front row seating 32. In particular, the equipment storage area 210 is positioned rearward of the seat bottom 200. In other embodiments (e.g., in embodiments where the vehicle 10 includes the rear row of seating 34), the equipment storage area 210 is positioned rearward of the rear row seating 34. As shown in FIG. 4-6 and 11-14, the equipment storage area 210 defines an equipment storage volume 212 that is configured to receive equipment (e.g., golf equipment). The equipment storage volume 212 extends substantially vertically and away from the body 20. In some embodiments, the vehicle 10 does not include the equipment storage area 210.

As shown in FIG. 4-6 and 12-14, the vehicle 10 includes an accessory storage component (e.g., a storage container, a basket, a sweater basket, a storage assembly, a first accessory storage device, etc.), shown as accessory storage device 220. In some embodiments, the vehicle 10 does not include the accessory storage device 220. The accessory storage device 220 is coupled to the body 20 and/or a canopy support structure of the vehicle 10. According to the exemplary embodiment shown in FIG. 4-6 and 11-14, the accessory storage device 220 is positioned rearward of the front row seating 32. In particular, the accessory storage device 220 is positioned rearward of the seat back 202. In other embodiments (e.g., in embodiments where the vehicle 10 includes the rear row of seating 34), the accessory storage device 220 is positioned rearward of the rear row seating 34. As shown in FIG. 4-6 and 12-14, the accessory storage device 220 includes a first portion, shown as bracket portion 222, a second portion, shown as basket portion 224, and a retainer, shown as equipment retention strap 226. The bracket portion 222 extends substantially longitudinally and away from the front row seating 32. The bracket portion 222 extends substantially towards the equipment storage volume 212, such that the bracket portion 222 facilitates unobstructed vertical and/or longitudinal access to and egress from the equipment storage area 210. The equipment retention strap 226 is coupled to the bracket portion 222 of the accessory storage device 220. According to an exemplary embodiment, the equipment retention strap 226 is configured to retain a piece of equipment positioned within the equipment storage volume 212 (e.g., one or more golf bags). For example, when the equipment is positioned at the equipment storage area 210, the equipment extends substantially vertically (within the equipment storage volume 212). The equipment retention strap 226 may be positioned around the equipment, such that the equipment retention strap 226 retains the equipment against the accessory storage device 220, or, more specifically, against the bracket portion 222. As shown in FIG. 4-6 and 12-14, the basket portion 224 extends vertically below the bracket portion 222. The basket portion 224 is positioned away from (e.g., forward of) the equipment storage volume 212 such that the basket portion 224 facilitates unobstructed vertical and/or longitudinal access to and egress from the equipment storage area 210. The basket portion 224 defines a volume, shown as accessory storage volume 228, that is configured to receive an accessory (e.g., a golf vehicle accessory, etc.) and/or additional equipment, such as additional golf equipment.

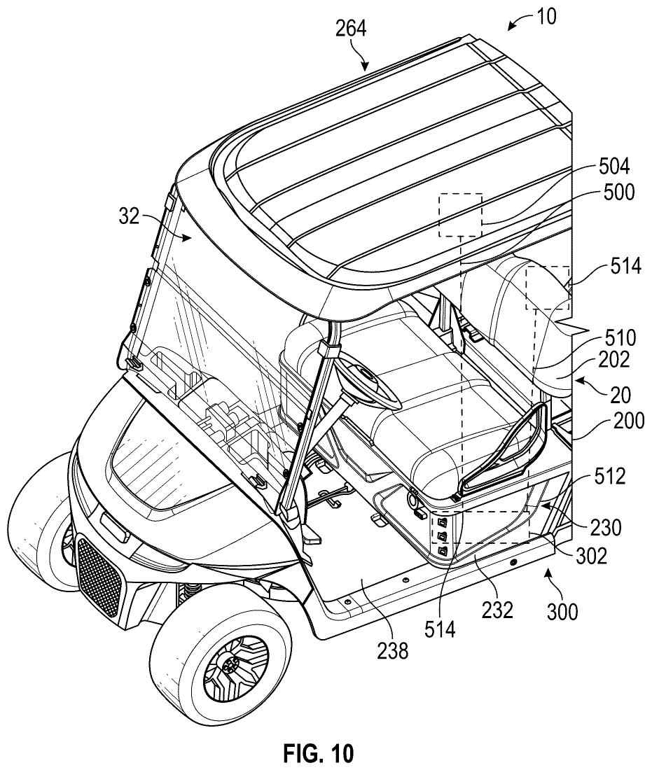

As shown in FIG. 10, the body 20 includes an under-seat portion, shown as seat pedestal 230, that extends directly beneath and supports the seat bottom 200. The seat pedestal 230 has a pair of lateral sides that extend along the left and right sides of the body 20, respectively, and a front side that extends between the lateral sides. The body 20 further includes a horizontal portion, shown as floor 238, that extends substantially horizontally, forward of the seat pedestal 230 and toward a front end of the vehicle 10. The floor 238 may support the feet of an occupant as the occupant steps into the vehicle 10 (e.g., to enter or exit the front row seating 32).

As shown in FIG. 10, the vehicle 10 includes a storage area (e.g., an accessory storage compartment, a second accessory storage device, etc.), shown as compartment 232. The seat pedestal 230 may at least partially define the compartment 232. The compartment 232 is positioned underneath the front row seating 32 (e.g., underneath the seat bottom 200). The compartment 232 is configured to receive an accessory (e.g., a golf vehicle accessory, etc.).

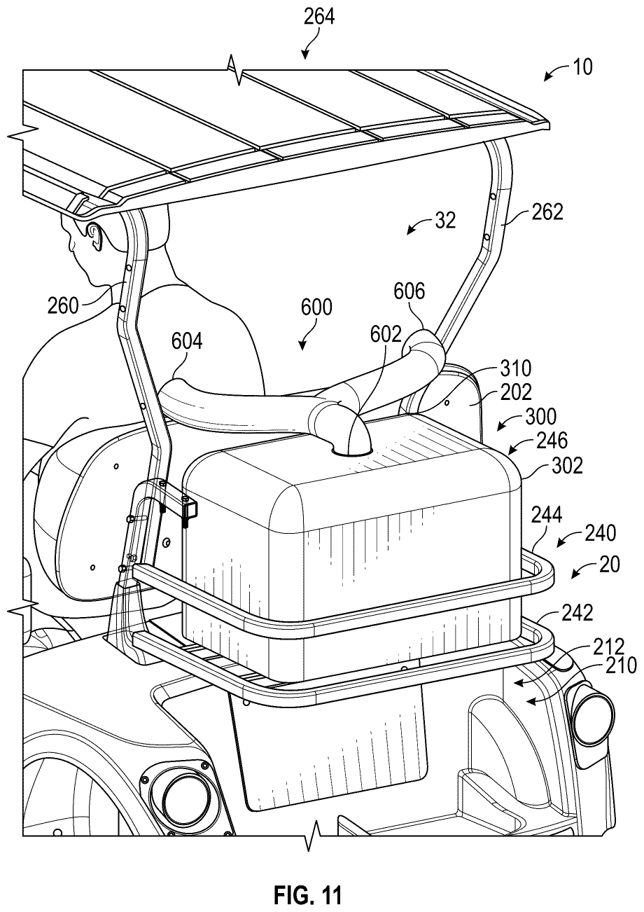

As shown in FIG. 11, the vehicle 10 does not include the accessory storage device 220. Rather, the vehicle 10 includes an accessory storage area (e.g., a third accessory storage device), shown as accessory storage device 240. The accessory storage device 240 is coupled to the body 20 and/or the canopy support structure of the vehicle 10. According to the exemplary embodiment shown in FIG. 11, the accessory storage device 240 is positioned rearward of the front row seating 32. In particular, the accessory storage device 240 is positioned rearward of the seat back 202. In other embodiments (e.g., in embodiments where the vehicle 10 includes the rear row of seating 34), the accessory storage device 240 is positioned rearward of the rear row seating 34. As shown in FIG. 11, the accessory storage device 240 includes a first frame portion, shown as base 242, and a second frame portion, shown as retainer 244. The base 242 extends substantially longitudinally and away from the front row seating 32. The base 242 extends substantially towards the equipment storage volume 212 such that the base 242 extends at least partially within equipment storage volume 212. In this way, the accessory storage device 240 at least partially prevents equipment from being positioned within the equipment storage volume 212. The retainer 244 is spaced away from and positioned vertically above the base 242. The base 242 and the retainer 244 cooperate to define a volume, shown as accessory storage volume 246. The accessory storage device 240 is configured to receive an accessory (e.g., a golf vehicle accessory) within the accessory storage volume 246.

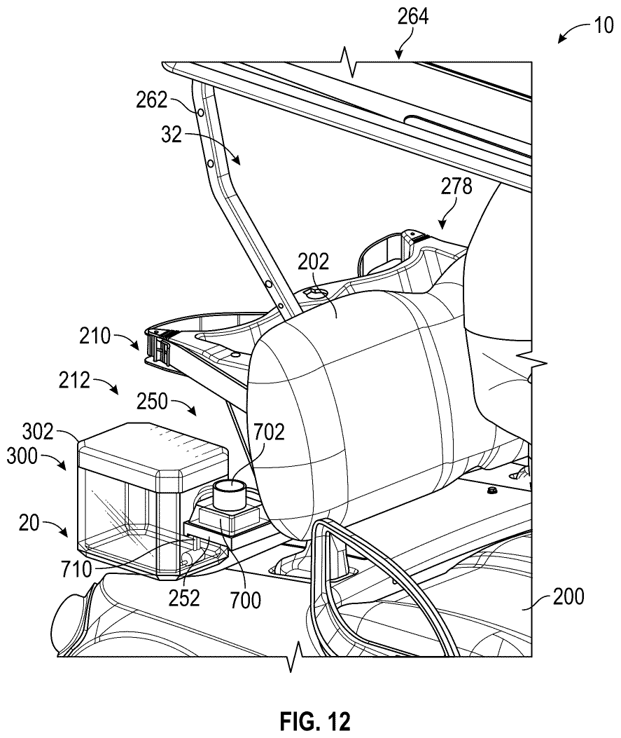

As shown in FIG. 12, the vehicle 10 includes an accessory coupling device (e.g., a fourth accessory storage device), shown as accessory coupling device 250. The accessory coupling device 250 is coupled to the body 20. According to the exemplary embodiment shown in FIG. 12, the accessory coupling device 250 is positioned rearward of the front row seating 32 and at a lateral side of the vehicle 10. In particular, the accessory coupling device 250 is positioned rearward of the seat back 202. In other embodiments (e.g., in embodiments where the vehicle 10 includes the rear row of seating 34), the accessory storage device 250 is positioned rearward of the rear row seating 34. As shown in FIG. 12, the accessory coupling device 250 is positioned laterally away from the accessory storage device 220 (e.g., in embodiments that include the accessory storage device 220). The accessory coupling device 250 is positioned laterally away from the equipment storage volume 212 such that the accessory coupling device 250 facilitates unobstructed vertical and/or longitudinal access to and egress from the equipment storage area 210. The accessory coupling device 250 includes a bracket, shown as mounting bracket 252. The mounting bracket 252 extends substantially longitudinally and away from the front row seating 32. The mounting bracket 252 is configured to couple an accessory (e.g., a golf vehicle accessory) to the vehicle 10.

As shown in FIG. 4-6 and 11-14, the vehicle 10 includes a canopy support structure including one or more frame members, shown as first frame member 260 and a second frame member 262. The first frame member 260 is positioned rearward of the seat back 202. The first frame member 260 extends away from the body 20 in a substantially vertical direction. The first frame member 260 is coupled to the body 20. The second frame member 262 is positioned rearward of the seat back 202 and spaced away from the first frame member 260. The second frame member 262 extends away from the body 20 in a substantially vertical direction. The second frame member 262 is coupled to the body 20. As described in greater detail herein, in some embodiments, at least one of the first frame member 260 or the second frame member 262 is configured to support a conduit (e.g., a tube, a fluid duct, an air duct, a hose, etc.). In some embodiments, the conduit may be positioned within the first frame member 260 and/or within the second frame member 262. In other embodiments, the conduit may be positioned proximate the first frame member 260 and/or proximate the second frame member 262. In these embodiments, the conduit may be coupled to at least one of the first frame member 260 or the second frame member 262. In some embodiments, the first frame member 260 and/of the second frame member 262 function as the conduits.

As shown in FIG. 4-6 and 10-14, the vehicle 10 includes a topper or roof, shown as canopy 264. The canopy is coupled to and supported by the canopy support structure including one or both of the first frame member 260 or the second frame member 262. The canopy 264 extends substantially horizontally above the front row seating 32, protecting the occupants from rain and sunlight. In some embodiments, the canopy 264 is removable. In some embodiments, the vehicle 10 does not include the canopy 264 and/or the canopy support structure.

### Golf Vehicle Accessory

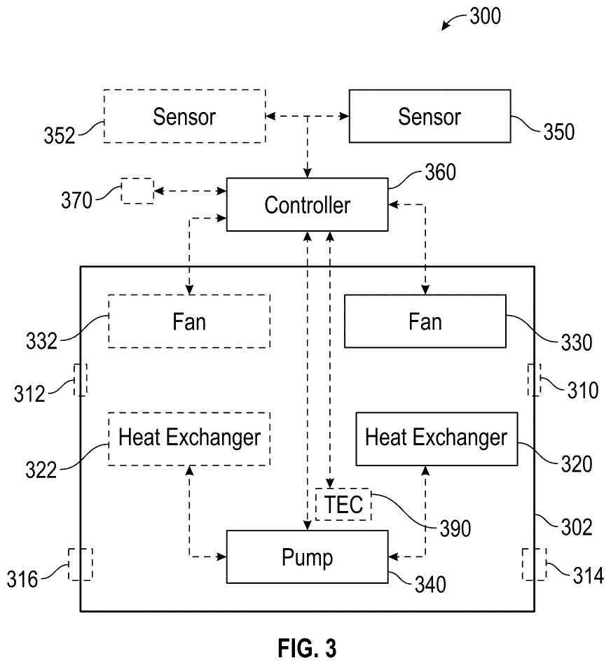

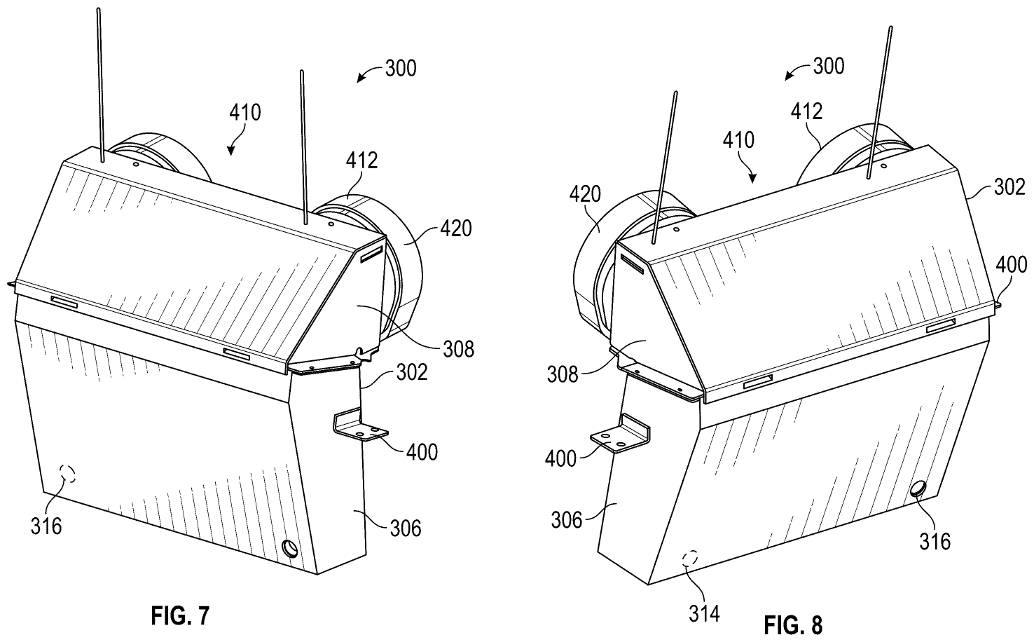

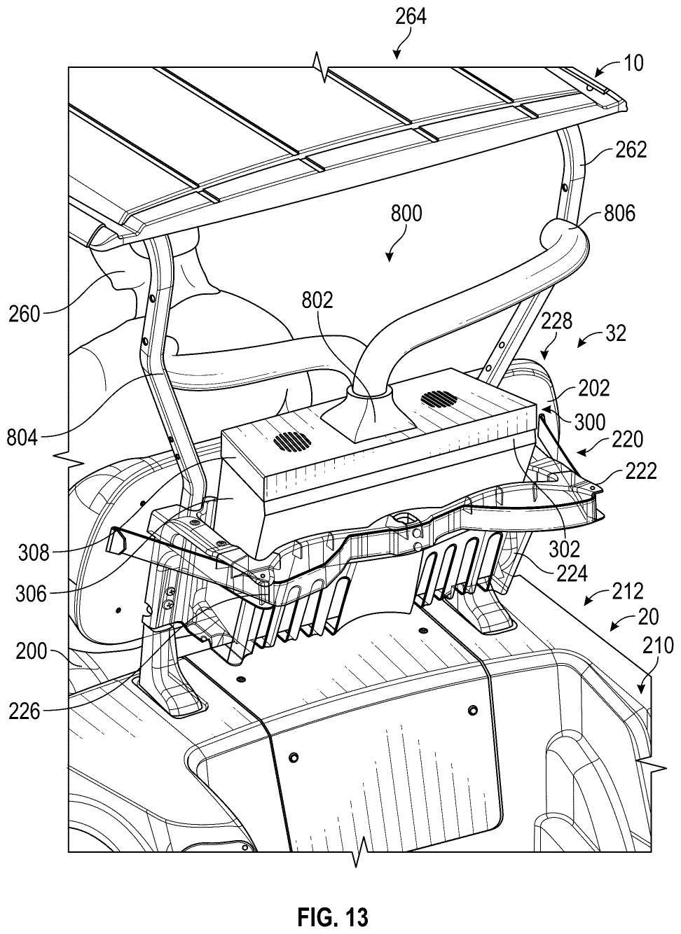

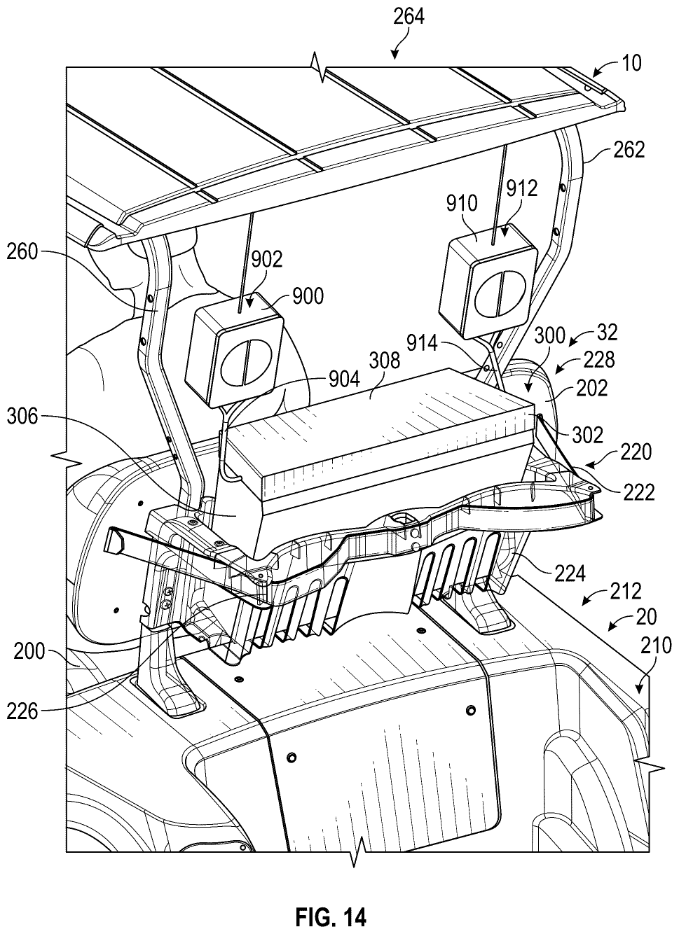

As shown in FIG. 3-14, the vehicle 10 includes an accessory (e.g., a cooling assembly, a cooling system, etc.), shown as golf vehicle accessory 300. As described herein, the golf vehicle accessory 300 may be provided in a plurality of different configurations. For example, as shown in FIG. 4-6, the vehicle 10 includes a first configuration of the golf vehicle accessory 300. Views of the first configuration of the golf vehicle accessory 300, without the vehicle 10, are shown in FIG. 7-9. As shown in FIG. 10, the vehicle 10 includes a second configuration of the golf vehicle accessory 300. As shown in FIG. 11, the vehicle 10 includes a third configuration of the golf vehicle accessory 300. As shown in FIG. 12, the vehicle 10 includes a fourth configuration of the golf vehicle accessory 300. As shown in FIG. 13, the vehicle 10 includes a fifth configuration of the golf vehicle accessory 300. As shown in FIG. 14, the vehicle 10 includes a sixth configuration of the golf vehicle accessory 300.

As shown in FIG. 3, the golf vehicle accessory 300 includes an accessory body, shown as housing 302. According to an exemplary embodiment, the housing 302 defines a housing volume that is configured to receive a coolant. As shown in FIG. 3, the golf vehicle accessory 300 includes at least one heat transfer device, shown as first heat exchanger 320 and a second heat exchanger 322. In some embodiments, the second heat exchanger 322 is optional and may be omitted. In some embodiments, the golf vehicle accessory 300 includes more than two heat exchangers (e.g., one for each occupant seating location in a multi-row embodiment). As shown in FIG. 3, the golf vehicle accessory 300 includes at least one air driver (e.g., a fan, a blower, etc.), shown as first fan 330 and second fan 332. In some embodiments, the second fan 332 is optional and may be omitted. In some embodiments, the golf vehicle accessory 300 includes more than two fans (e.g., one for each occupant seating location in a multi-row embodiment). As shown in FIG. 3, the golf vehicle accessory 300 includes a fluid transfer device, shown as pump 340. The pump 340 is positioned within the housing volume of the housing 302. In some embodiments, the golf vehicle accessory 300 includes two or more pumps 340 (e.g., one associated with each heat exchanger). As shown in FIG. 3, the golf vehicle accessory 300 includes a control system, shown as controller 360. In some embodiments, the golf vehicle accessory 300 does not include the controller 360. In such embodiments, the golf vehicle accessory 300 may be controlled by the vehicle control system 100.

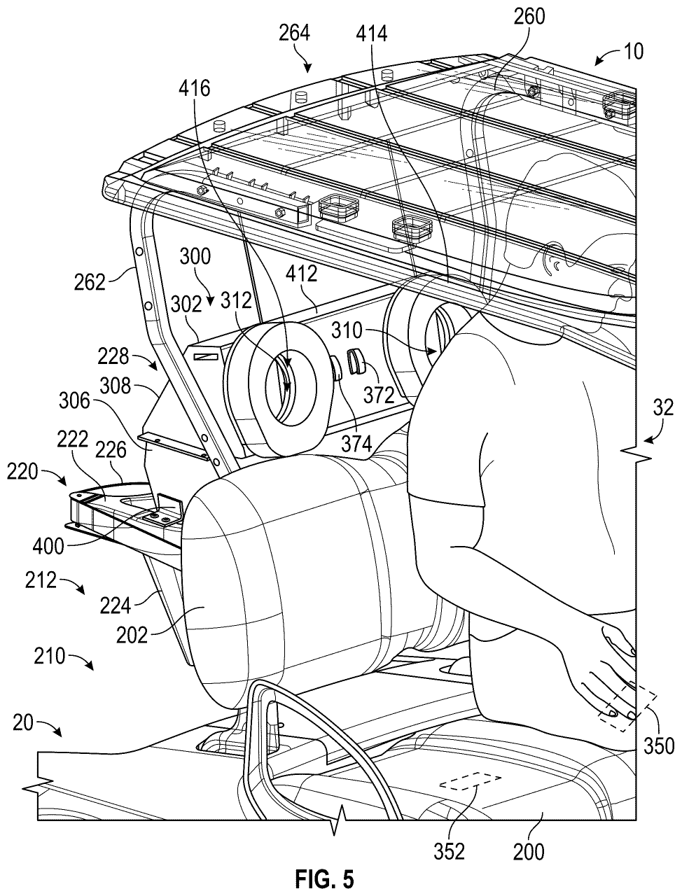

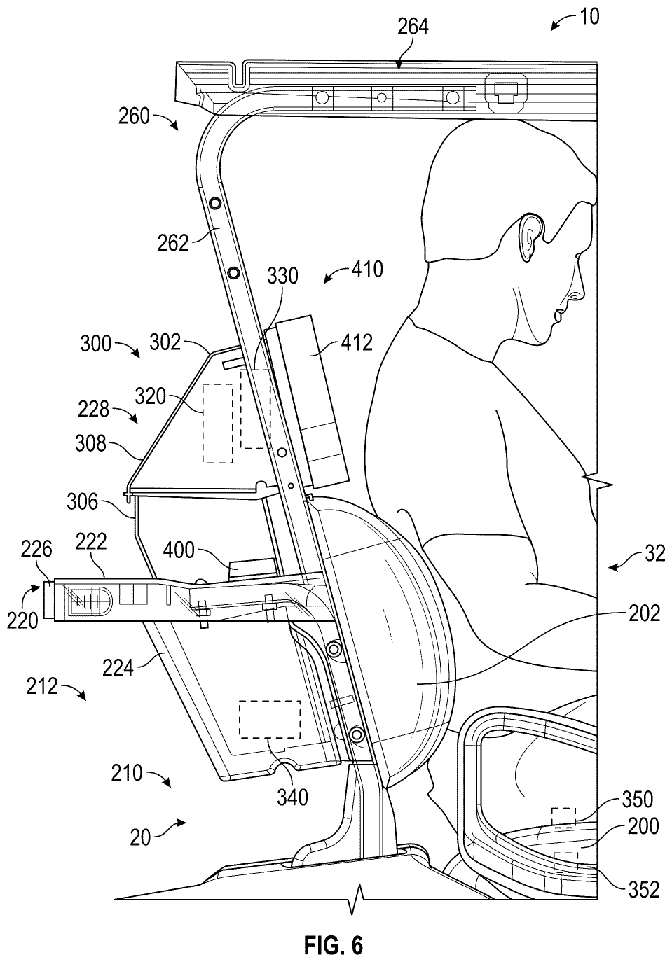

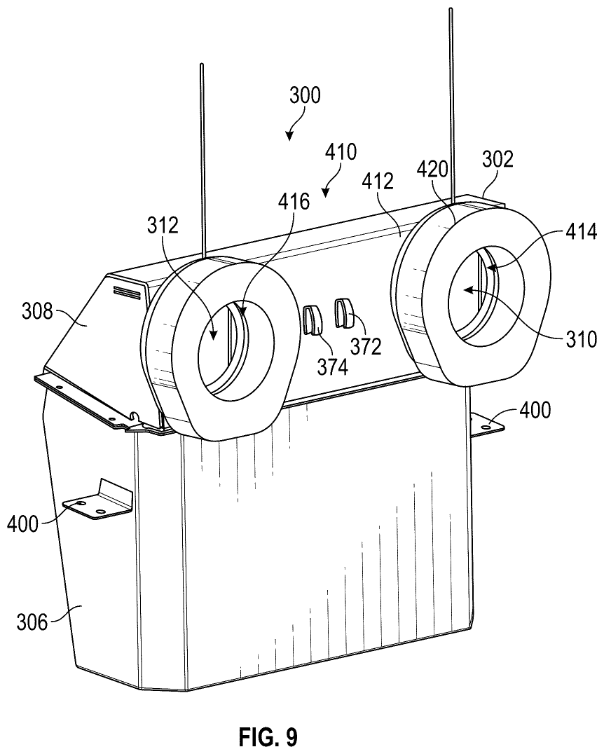

As shown in FIG. 4-9, the housing 302 includes a first housing portion (e.g., a coolant housing, a pump housing, a lower housing, etc.), shown as lower housing portion 306, and a second housing portion (e.g., a cowl, an upper housing, a heat exchanger and fan housing, etc.), shown as upper housing portion 308. In other embodiments (see, e.g., FIG. 11), the housing 302 includes a single exterior housing portion. In such embodiments, the housing volume may be internally divided into multiple sub-chambers. In embodiments including the lower housing portion 306 and the upper housing portion 308, the lower housing portion 306 defines the housing volume. In some embodiments, the housing volume is at least about thirty liters (e.g., 28 liters, 30 liters, 35 liters, etc.). As shown in FIG. 4-9, the upper housing portion 308 is supported by the lower housing portion 306. As shown in FIGS. 5 and 9, the upper housing portion 308 defines one or more openings, shown as first opening 310 and second opening 312. As shown in FIG. 6, (a) the pump 340 is disposed within the lower housing portion 306 and (b)the first heat exchanger 320 and the first fan 330 are disposed within the upper housing portion 308. In other embodiments, one or both of the first heat exchanger 320 and the first fan 330 are otherwise positioned (e.g., within the lower housing portion 306). The second heat exchanger 322 and the second fan 332 may be similarly positioned at the first heat exchanger 320 and the first fan 330. According to an exemplary embodiment, the first fan 330 is configured to selectively provide air through the first opening 310 and the second fan 332 is configured to selectively provide air through the second opening 312. In some embodiments (e.g., embodiments where when the golf vehicle accessory 300 does not include the second heat exchanger 322 and the second fan 332), the housing 302 does not include the second opening 312 or the first fan 330 provides air through both the first opening 310 and the second opening 312.

As shown in FIGS. 3, 7, and 8, the housing 302 defines a first port, shown as inlet port 314. The inlet port 314 extends through a wall of the housing 302. The inlet port 314 is in fluid providing communication with the housing volume. The inlet port 314 is configured to removably couple to a fluid supply line such that the housing 302 can receives the coolant from the fluid supply line via the inlet port 314. In some embodiments, a quick connect fitting is provided at the inlet port 314 such that the fluid supply line can be connected to the housing 302 via the quick connect fitting. In some embodiments, the inlet port 314 includes a one-way valve to prevent the coolant from flowing out of the housing 302 through the inlet port 314. In some embodiments, the housing 302 does not include the inlet port 314. In such embodiments, the housing 302 may include a panel or door that is openable to provide access to fill the housing 302 with the coolant. Alternatively, the upper housing portion 308 may pivot relative to the lower housing portion 306 to provide access to fill the housing 302 with the coolant

As shown in FIGS. 3, 7, and 8, the housing 302 defines a second port, shown as outlet port 316. The outlet port 316 extends through the wall of the housing 302. The outlet port 316 in fluid receiving communication with the housing volume. In some embodiments, the outlet port 316 is configured to removably couple to a fluid receiving line such that the housing 302 provides the coolant to the fluid receiving line via the outlet port 316. In some embodiments, a quick connect fitting is provided at the outlet port 316 such that the fluid receiving line can be connected to the housing 302 via the quick connect fitting.

In an example operating scenario, a user (e.g., an operator, an employee, etc.) may removably couple the fluid supply line to the inlet port 314 such that the housing 302 receives the coolant from the fluid supply line via the inlet port 314 to fill the housing 302 with the coolant. In another example operating scenario, the user may removably couple the fluid receiving line to the outlet port 316 such that the housing 302 provides the coolant to the fluid receiving line via the outlet port 316 to empty the coolant from the housing 302.

In other embodiments, the housing 302 includes only one of the inlet port 314 or the outlet port 316. For example, as shown in FIGS. 7-9, the outlet port 316 is optional, and may be omitted. In these embodiments, the inlet port 314 may act as both an inlet and an outlet for the housing 202. For example, the inlet port 314 may be structured as both the inlet port 314 and the outlet port 316, described above.

In another example operating scenario, the housing 302 may be fluidly coupled to a second housing. In these embodiments, coolant may travel from the second housing to the housing 302, to the first heat exchanger 320 and/or the second heat exchanger 322, and back to the second housing. In this way, the golf vehicle accessory 300 is modular, allowing for multiple housings to be combine. Advantageously, when additional housings are coupled to the housing 302, the amount of coolant in the golf vehicle accessory 300 increases allowing the golf vehicle accessory 300 to operate for longer periods of time.

In some embodiments, the housing 302 includes one or more housing wall layers, such as a first housing wall layer and a second housing wall layer. In some embodiments, the one or more housing walls layers are made of a plastic material, a metal material, such as steel, or another suitable material. The first housing wall layer is separated from the second housing wall layer such that a housing wall volume is defined between the first housing wall layer and the second housing wall layer. In some embodiments, an insulating member is positioned in the housing wall volume. In some embodiments, the insulating member is a foam material such as a mylar coated closed cell foam or other suitable material. In other embodiments, the housing wall volume is a sealed volume, such that fluids, and, in particular, gases, are substantially retained within the housing wall volume. In these embodiments, the housing wall volume may be filled with a gas, such as air. Alternatively, gas may be substantially evacuated from the housing wall volume so as to form a vacuum therein. In any of these embodiments, the separation of the first housing wall layer and the second housing wall layer substantially mitigates heat transfer through the one or more walls of the housing 302. Beneficially, the relatively low heat transfer through the one or more walls of the housing 302 may result in decreased heat transfer from ambient air to the coolant within the housing 302.

According to an exemplary embodiment, the coolant is an ice-water mixture. Thus, the coolant includes a liquid phase and a solid phase. In some embodiments, the coolant may also include a salt, such as a sodium chloride, calcium chloride, or other suitable salt.

According to an exemplary embodiment, the first heat exchanger 320 is a device, assembly, or system used to transfer heat from ambient air to the coolant. For example, the first heat exchanger 320 may be a shell and tube heat exchanger, a finned tube heat exchanger, or other suitable heat exchanger. In an exemplary embodiment, the first heat exchanger 320 is a finned tube heat exchanger. In some embodiments, and as shown in FIG. 3, the first heat exchanger 320 is positioned within the housing 302. In these embodiments, the first heat exchanger 320 is coupled to the housing 302. In an example embodiment, the first heat exchanger 320 is positioned in the upper housing portion 308. In another example embodiment, the first heat exchanger 320 is positioned proximate the first opening 310 of the housing 302. In other embodiments, the first heat exchanger 320 is positioned outside the housing 302. In these embodiments, the first heat exchanger 320 is coupled to a portion of the vehicle 10, such as the front row seating 32, the canopy 264, or another portion of the vehicle 10. When the first heat exchanger 320 is provided outside the housing 302, the first heat exchanger 320 is positioned within a first heat exchanger housing, as described herein below. In any of the above-described embodiments, the first heat exchanger 320 is positioned at or proximate a first seat of the front row seating 32. In operation, the first heat exchanger 320 is configured to receive the coolant (e.g., from the pump 340). The first heat exchanger 320 is configured to receive the air (e.g., from the first fan 330). The first heat exchanger 320 is configured to facilitate heat transfer from the air to the coolant, such that the air is cooled.

The second heat exchanger 322 may be substantially similar to or the same as the first heat exchanger 320. For example, the second heat exchanger 322 may be a shell and tube heat exchanger, a finned tube heat exchanger, or other suitable heat exchanger. In an exemplary embodiment, the second heat exchanger 322 is a finned tube heat exchanger. In some embodiments, the first heat exchanger 320 and the second heat exchanger 322 are made of a metal material, such as aluminum or copper. In some embodiments, and as shown in FIG. 3, the second heat exchanger 322 is positioned within the housing 302. In these embodiments, the second heat exchanger 322 is coupled to the housing 302. In an example embodiment, the second heat exchanger 322 is positioned in the upper housing portion 308. In another example embodiment, the second heat exchanger 322 is positioned proximate the second opening 312 of the housing 302. In other embodiments, the second heat exchanger 322 is positioned outside the housing 302. In these embodiments, the second heat exchanger 322 is coupled to a portion of the vehicle 10, such as the front row seating 32, the canopy 264, or another portion of the vehicle 10. When the second heat exchanger 322 is provided outside the housing 302, the second heat exchanger 322 is within a second heat exchanger housing, as described herein below. In any of the above-described embodiments, the second heat exchanger 322 is spaced away from the first heat exchanger 320, and the second heat exchanger 322 is positioned at or proximate a second seat of the front row seating 32. In operation, the second heat exchanger 322 is configured to receive the coolant (e.g., from the pump 340). The second heat exchanger 322 is configured to receive the air (e.g., from the second fan 332). The second heat exchanger 322 is configured to facilitate heat transfer from the air to the coolant, such that the air is cooled.

According to an exemplary embodiment, the first fan 330 is an axial fan configured to push or pull air (e.g., ambient air) across the first heat exchanger 320. In some embodiments, the first fan 330 is a water-resistant fan. In some embodiments, and as shown in FIG. 3, the first fan 330 is positioned within the housing 302. In these embodiments, the first fan 330 is coupled to the housing 302. In an example embodiment, the first fan 330 is positioned in the upper housing portion 308. In another example embodiment, the first fan 330 is positioned proximate the first opening 310 of the housing 302, such that the first fan 330 is configured to provide the air through the first opening 310. In other embodiments, the first fan 330 is positioned outside the housing 302. In these embodiments, the first fan 330 is coupled to a portion of the vehicle 10, such as the front row seating 32, the canopy 264, or another portion of the vehicle 10. When the first fan 330 is provided outside the housing 302, the first fan 330 is provided within the first heat exchanger housing, as described herein below. In any of the above-described embodiments, the first fan 330 is positioned at or proximate the first seat of the front row seating 32. In particular, the first fan 330 is positioned at or proximate the first seat of the front row seating 32 such that the first fan 330 is operable to provide the airflow towards an occupant of the first seat.

According to an exemplary embodiment, the first fan 330 is positioned proximate the first heat exchanger 320 such that the first fan 330 provides the airstream through the first heat exchanger 320. As described above, when the air passes through the first heat exchanger 320, heat is transferred from the air to the coolant, thereby cooling the air. In some embodiments, the first fan 330 and the first heat exchanger 320 are provided in a “pull” configuration, whereby the first fan 330 is positioned downstream of the first heat exchanger 320, and the first fan 330 “pulls” air through the first heat exchanger 320. In some embodiments, the first fan 330 and the first heat exchanger 320 are provided in a “push” configuration, whereby the first fan 330 is positioned upstream of the first heat exchanger 320, and the first fan 330 “pushes” air through the first heat exchanger 320. In other embodiments, the golf vehicle accessory 300 includes two first fans 330, and the first fans 330 and the first heat exchanger 320 are provided in a “push-pull” configuration, whereby the first fans 330 push and pull air through the first heat exchanger 320.

The first fan 330 is configured to selectively provide air through the first heat exchanger 320 to facilitate providing a cooled airflow to the operator (e.g., an operator occupying a first seat of the front row seating 32). The fan is operable between a first fan state and a second fan state. The first fan 330 is off when operating in the first fan state. The first fan 330 is configured to provide the air through the first heat exchanger 320 and toward the operator when the first fan 330 is operating in the second fan state.

In some embodiments, the first fan 330 is electrically coupled to the energy storage 54 such that the first fan 330 receives electrical energy from the energy storage 54. In some embodiments, the first fan 330 is electrically coupled to the controller 360 such that the first fan 330 receives electrical energy via the controller 360.

According to an exemplary embodiment, the second fan 332 is an axial fan configured to push or pull air (e.g., ambient air) across the second heat exchanger 322. In some embodiments, the second fan 332 is a water-resistant fan. In some embodiments, and as shown in FIG. 3, the second fan 332 is positioned within the housing 302. In these embodiments, the second fan 332 is coupled to the housing 302. In an example embodiment, the second fan 332 is positioned in the upper housing portion 308. In another example embodiment, the second fan 332 is positioned proximate the second opening 312 of the housing 302, such that the second fan 332 is configured to provide the air through the second opening 312. In other embodiments, the second fan 332 is positioned outside the housing 302. In these embodiments, second fan 332 is coupled to a portion of the vehicle 10, such as the front row seating 32, the canopy 264, or another portion of the vehicle 10. When the second fan 332 is provided outside the housing 302, the second fan 332 is provided within the second heat exchanger housing, as described herein below. In any of the above-described embodiments, the second fan 332 is positioned at or proximate the second seat of the front row seating 32. In particular, the second fan 332 is positioned at or proximate the second seat of the front row seating 32, such that the second fan 332 is operable to provide the airflow towards an occupant of the second seat.

According to an exemplary embodiment, the second fan 332 is positioned proximate the second heat exchanger 322 such that the second fan 332 provides the airstream through the second heat exchanger 322. As described above, when the air passes through the second heat exchanger 322, heat is transferred from the air to the coolant, thereby cooling the air. In some embodiments, the second fan 332 and the second heat exchanger 322 are provided in a “pull” configuration, where the second fan 332 is positioned downstream of the second heat exchanger 322, and the second fan 332 “pulls” air through the second heat exchanger 322. In some embodiments, the second fan 332 and the second heat exchanger 322 are provided in a “push” configuration, where the second fan 332 is positioned upstream of the second heat exchanger 322, and the second fan 332 “pushes” air through the second heat exchanger 322. In other embodiments, the golf vehicle accessory 300 includes two second fans 332, and the second fans 332 and the second heat exchanger 322 are provided in a “push-pull” configuration, whereby the second fans 332 push and pull air through the second heat exchanger 322.

The second fan 332 is configured to selectively provide air through the second heat exchanger 322 to facilitate providing a cooled airflow to the operator (e.g., an operator occupying the second seat of the front row seating 32). The second fan 332 is operable between a first fan state and a second fan state. The second fan 332 is off when operating in the first fan state. The second fan 332 is configured to provide the air through the second heat exchanger 322 and toward the operator when the second fan 332 is operating in the second fan state.

In some embodiments, the second fan 332 is electrically coupled to the energy storage 54 such that the second fan 332 receives electrical energy from the energy storage 54. In some embodiments, the second fan 332 is electrically coupled to the controller 360 such that the second fan 332 receives electrical energy via the controller 360.

The pump 340 may be a submersible pump, a positive displacement pump, a rotodynamic pump, or other suitable pump. In an example embodiment, the pump 340 is a 12 volt, PWM controlled pump. The pump 340 is positioned within the housing 302. In particular, the pump 340 is submerged in the coolant such that the pump 340 receives the coolant at a pump inlet and provides the coolant at a pump outlet. The pump 340 is configured to provide the coolant to a downstream component, such as one or both of the first heat exchanger 320 and the second heat exchanger 322. More specifically, the pump 340 is fluidly coupled to the first heat exchanger 320 and/or the second heat exchanger 322. The pump 340 is configured to selectively provide the coolant to the first heat exchanger 320 and/or the second heat exchanger 322. The pump 340 is operable between a first pump state and a second pump state. The first pump state is an off state where the pump 340 is off. The second pump state is an on state where the pump 340 provides the coolant to the first heat exchanger 320 and/or the second heat exchanger 322.

In some embodiments, the pump 340 is electrically coupled to the energy storage 54 such that the pump 340 receives electrical energy from the energy storage 54. In some embodiments, the pump 340 is electrically coupled to the controller 360 such that the pump 340 receives electrical energy via the controller 360.

As shown in FIGS. 3, 5, and 6, The vehicle 10 includes one or more sensors, shown as first sensor 350 and a second sensor 352. In some embodiments, the first sensor 350 and the second sensor 352 are included in the sensors 90 of the vehicle 10. In these embodiments, the first sensor 350 and/or the second sensor 352 are coupled to the golf vehicle accessory 300. In other embodiments, the first sensor 350 and the second sensor 352 are separate from the sensors 90 and are part of the golf vehicle accessory 300. That is, in some embodiments, the golf vehicle accessory 300 includes the first sensor 350 and/or the second sensor 352. In any of the above-described embodiments, the first sensor 350 is coupled, and, in particular, communicably coupled to the pump 340 and the first fan 330, and the second sensor 352 is coupled to the pump 340 and the second fan 332. The first sensor 350 and/or the second sensor is coupled, and, in particular, communicably coupled to the front row seating 32. As shown in FIG. 3, the first sensor 350 and the second sensor 352 are positioned outside of the housing 302. In some embodiments, the second sensor 352 is optional and may be omitted.

In some embodiments, the first sensor 350 and/or the second sensor 352 includes at least one of a seat switch, a floor switch, a proximity sensor, a camera, or a weight sensor. The seat switch is coupled to the seat bottom 200. More specifically, the seat switch is positioned at or proximate the seat bottom 200. The seat switch is biased to a first sensor position such that the seat switch is in the first sensor position when the seat is unoccupied and a second sensor position when the seat is occupied. For example, when an operator is seated on the seat, the seat switch is in the second sensor position. The floor switch is coupled to the floor 238. More specifically, the floor switch is positioned at or proximate the floor 238. The floor switch is biased to a first sensor position such that the floor switch is in the first sensor position when the seat is unoccupied and a second sensor position when the seat is occupied. For example, when the operator is seated on the seat, the operator's feet cause the seat switch to be in the second sensor position. In other embodiments, when the first sensor 350 and/or the second sensor 352 includes a proximity sensor, a camera, or a weight sensor, the sensor is configured to acquire data regarding the presence of an occupant at the front row seating 32 (or the rear row seating 34).

The first sensor 350 is configured to detect a presence of an operator. More specifically, the first sensor 350 is configured to detect the presence of the operator in the first seat of the front row seating 32. Accordingly, the first sensor 350 is coupled to the front row seating 32 such that the first sensor 350 is positioned to detect the presence of the operator in the first seat of the front row seating 32. The first sensor 350 is configured to provide a first signal when the presence of the operator is not detected. The first signal causes the first fan 330 to operate at the first fan state and the pump 340 to operate at the first pump state. The first sensor 350 is configured to provide a second signal when the presence of the operator is detected. The second signal causes the first fan 330 to operate at the second fan state and the pump 340 to operate at the second pump state.

The second sensor 352 is configured to detect a presence of an occupant. More specifically, the second sensor 352 is configured to detect the presence of the occupant in the second seat of the front row seating 32. Accordingly, the second sensor 352 is coupled to the front row seating 32 such that the second sensor 352 is positioned to detect the presence of the occupant in the second seat of the front row seating 32. The second sensor 352 is configured to provide a first signal when the presence of the occupant is not detected. The first signal causes the second fan 332 to operate at the first fan state and the pump 340 to operate at the first pump state. The second sensor 352 is configured to provide a second signal when the presence of the occupant is detected. The second signal causes the second fan 332 to operate at the second fan state and the pump 340 to operate at the second pump state.

In some embodiments, the controller 360 is part of the or the same as the vehicle control system 100. In other embodiments, the controller 360 is separate from the vehicle control system 100. The controller 360 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. In some embodiments, the controller 360 includes a processing circuit 102, a memory 104, and a communications interface 106, similar to the processing circuit 102, the memory 104, and the communications interface 106 of the vehicle control system 100. In one embodiment, the controller 360 is configured to selectively engage, selectively disengage, control, or otherwise communicate with components of the vehicle 10 (e.g., via the communications interface, a controller area network (“CAN”) bus, etc.). According to an exemplary embodiment, the controller 360 is coupled to (e.g., communicably coupled to) components of the golf vehicle accessory 300 (e.g., the first heat exchanger 320, the second heat exchanger 322, the first fan 330, the second fan 332, the pump 340, the first sensor 350, the second sensor 352, etc.). By way of example, the controller 360 may send and receive signals (e.g., control signals, location signals, etc.) with the components of the golf vehicle accessory 300. In another exemplary embodiment, the controller 360 may be implemented as a relay that is configured to facilitate communicably coupling the first sensor 350 to the first fan 330 and the pump 340 and/or communicably coupling the second sensor 352 to the second fan 332 and the pump 340.

The controller 360 is configured to receive one of the first signal or the second signal from the first sensor 350. Responsive to receiving the first signal from the first sensor 350, the controller 360 is configured to cause the first fan 330 to operate at the first fan state and the pump 340 to operate at the first pump state. Responsive to receiving the second signal from the first sensor 350, the controller 360 is configured to cause the first fan 330 to operate at the second fan state and the pump 340 to operate at the second pump state.

The controller 360 is configured to receive one of the first signal or the second signal from the second sensor 352. Responsive to receiving the first signal from the second sensor 352, the controller 360 is configured to cause the second fan 332 to operate at the first fan state and the pump 340 to operate at the first pump state. Responsive to receiving the second signal from the second sensor 352, the controller 360 is configured to cause the second fan 332 to operate at the second fan state and the pump 340 to operate at the second pump state. In some embodiments, the vehicle 10 does not include the second sensor 352 such that the controller 360 controls the pump 340, the first fan 330, and the second fan 332 based on the signals provided by the first sensor 350.

In some embodiments, the golf vehicle accessory 300 includes one or more switches, shown as switch 370. As shown in FIG. 3, the golf vehicle accessory 300 includes one switch 370. In some embodiments, the golf vehicle accessory 300 does not include the switch 370. The switch 370 is coupled to the first fan 330, the second fan 332, and/or the pump 340. The switch 370 is selectively positionable between a first switch position and a second switch position. The switch 370 prevents the first fan 330 and/or the second fan 332 from operating at the second fan state and prevents the pump 340 from operating at the second pump state when the switch 370 is in the first switch position. The switch 370 allows the first fan 330 and the second fan 332 to operate at the second fan state and allows the pump 340 to operate at the second pump state when the switch 370 is in the second switch position and at least one of the first sensor 350 or the second sensor 352 provides the second signal. In some embodiments, the switch 370 only controls the second fan 332 (e.g., such that the second fan 332 can be turned off independent of the first fan 330 and the pump 340).

As shown in FIGS. 5 and 9, the golf vehicle accessory 300 includes a first switch 372 and a second switch 374. In some embodiments, the golf vehicle accessory 300 includes one of the first switch 372 or the second switch 374. In these embodiments, the one of the first switch 372 or the second switch 374 operates as the switch 370, described above. In some embodiments, the golf vehicle accessory 300 does not include either of the first switch 372 or the second switch 374. According to an exemplary embodiment, the first switch 372 is coupled to the first fan 330 and/or the pump 340. The first switch 372 is selectively positionable between a first switch position and a second switch position. The first switch 372 prevents the first fan 330 from operating at the second fan state and prevents the pump 340 from operating at the second pump state when the first switch 372 is in the first switch position. The first switch 372 allows the first fan 330 to operate at the second fan state and allows the pump 340 to operate at the second pump state when the first switch 372 is in the second switch position and the first sensor 350 provides the second signal. According to an exemplary embodiment, the second switch 374 is coupled to the second fan 332 and/or the pump 340. The second switch 374 is selectively positionable between a first switch position and a second switch position. The second switch 374 prevents the second fan 332 from operating at the second fan state and prevents the pump 340 from operating at the second pump state when the second switch 374 is in the first switch position. The second switch 374 allows the second fan 332 to operate at the second fan state and allows the pump 340 to operate at the second pump state when the second switch 374 is in the second switch position and the second sensor 352 provides the second signal.

As shown in FIG. 3, the golf vehicle accessory 300 includes an electric cooling device (e.g., a Peltier device, Peltier heat pump, solid state refrigerator, or thermoelectric cooler), shown as thermoelectric cooler 390. In some embodiments, the golf vehicle accessory 300 does not include the thermoelectric cooler 390. As shown in FIG. 3, the thermoelectric cooler 390 is positioned within the housing 302 and is configured to cool the coolant in the housing 302. The thermoelectric cooler 390 may be electrically coupled to the energy storage 54 of the vehicle 10 such that the thermoelectric cooler 390 receives electrical energy from the energy storage 54.

As shown in FIG. 4-6, the golf vehicle accessory 300 is at least partially positioned within the accessory storage device 220. More specifically, at least a portion of the lower housing portion 306 is positioned within the accessory storage device 220.

As shown in FIG. 7-9, the golf vehicle accessory 300 includes brackets (e.g., L-brackets, flanges, etc.), shown as mounting bracket 400, extending from opposing lateral sides of the lower housing portion 306. As shown in FIG. 4-6, mounting brackets 400 couple the golf vehicle accessory 300 to the bracket portions 222 of the accessory storage device 220. The mounting brackets 400 may be coupled to the bracket portions 222 by one or more fasteners (e.g., bolts, screws, etc.). The mounting brackets 400 may be coupled to the lower housing portion 306 by one or more fasteners, welded thereto, or integrally formed therewith. In some embodiments, anti-vibration material, such as an anti-vibration adhesive or an anti-vibration washer, is disposed on the fasteners to mitigate loosening of the fasteners due to vibration of the vehicle 10.

As shown in FIG. 4-9, the golf vehicle accessory 300 includes a headrest assembly 410. In other embodiments, the headrest assembly 410 is integrated into or coupled to the seat back 202. As shown in FIG. 4-6, the headrest assembly 410 is positioned proximate the front row seating 32. In particular, the headrest assembly 410 is positioned substantially vertically above the seat back 202. As shown in FIG. 4-6, the golf vehicle accessory 300 is positioned such that a top surface of the golf vehicle accessory 300 is at or below a horizontal plane defined by a top of the headrest assembly 410.

As shown in FIG. 4-9, the headrest assembly 410 includes head rests, shown as head supports 412. The head supports 412 define one or more openings, shown as first opening 414 and second opening 416. The first fan 330 is configured to provide the air through the first opening 414. The second fan 332 is configured to provide the air through the second opening 416. The headrest assembly 410 includes wraps, shown as covers 420. The covers 420 are wrapped around the head supports 412. The covers 420 are made of a fabric material, a vinyl material, or other suitable material. In some embodiments, the covers 420 extends over the first opening 414 and the second opening 416. The covers 420 may define a plurality of airflow apertures or slits to permit airflow therethrough.

As shown in FIG. 10, the vehicle 10 includes a second configuration of the golf vehicle accessory 300. The golf vehicle accessory 300 is at least partially positioned within the compartment 232. For example, the housing 302 is positioned within the compartment 232. In the embodiment shown in FIG. 10, the first heat exchanger 320, the second heat exchanger 322, the first fan 330, and the second fan 332 are positioned within the housing 302.

As shown in FIG. 10, the golf vehicle accessory 300 includes tubes (e.g., a conduits, etc.), shown as first hose 500 and second hose 510. The first hose 500 has a first end 502 positioned to receive the air from the first fan 330 and a second end 504 positioned to provide the air at a location away from the first end 502. As shown in FIG. 10, the second end 504 is positioned proximate the front row seating 32. More specifically, the second end 504 is positioned proximate the first seat of the front row seating 32. The second end 504 of the first hose 500 may be selectively repositionable. For example, an operator may manipulate the first hose 500 to adjust a position of the second end 504. The second hose 510 has a first end 512 positioned to receive the air from the second fan 332 and a second end 514 positioned to provide the air at a location away from the first end 512. In some embodiments, the first hose 500 is supported by the first frame member 260. In an example embodiment, the first hose 500 is coupled to the first frame member 260. In another example embodiment, the first hose 500 is at least partially positioned within the first frame member 260. As shown in FIG. 10, the second end 514 is positioned proximate the front row seating 32. More specifically, the second end 514 is positioned proximate the second seat of the front row seating 32. The second end 514 of the second hose 510 may be selectively repositionable. For example, an operator may manipulate the second hose 510 to adjust a position of the second end 514. In some embodiments, the second hose 510 is supported by the second frame member 262. In an example embodiment, the second hose 510 is coupled to the second frame member 262. In another example embodiment, the second hose 510 is at least partially positioned within the second frame member 262. In some embodiments, the first frame member 260 and the second frame member 262 function as conduits and define outlets that provide the cooled airflow to the occupants. Airflow diffusers may be positioned at the outlets to disperse or facilitate occupant manipulation of the direction of the airflow.

As shown in FIG. 11, the vehicle 10 includes a third configuration of the golf vehicle accessory 300. The golf vehicle accessory 300 is at least partially positioned within the accessory storage device 240. For example, at least a portion of the housing 302 is positioned within the accessory storage device 240.

As shown in FIG. 11, the golf vehicle accessory 300 includes a tube (e.g., a conduit, etc.), shown as ducting 600. The ducting 600 has a first end 602 positioned to receive the air from the first fan 330. The ducting 600 is configured to split the received air into a first portion and a second portion. The ducting 600 has a second end 604 positioned to provide the first portion of the air at a location away from the first end 602 and a third end 606 positioned to provide the second portion of the air at a location away from the first end 602 and away from the second end 604. As shown in FIG. 11, the second end 604 is positioned proximate the front row seating 32. More specifically, the second end 604 is positioned proximate the first seat of the front row seating 32. The second end 604 of the ducting 600 may be selectively repositionable. For example, an operator may manipulate the ducting 600 to adjust a position of the second end 604. As shown in FIG. 11, the third end 606 is positioned proximate the front row seating 32. More specifically, the third end 606 is positioned proximate the second seat of the front row seating 32. The third end 606 of the ducting 600 may be selectively repositionable. For example, an operator may manipulate the ducting 600 to adjust a position of the third end 606.

As shown in FIG. 12, the vehicle 10 includes a fourth configuration of the golf vehicle accessory 300. The golf vehicle accessory 300 is coupled to the body 20 of the vehicle 10 by the accessory coupling device 250. More specifically, the housing 302 is coupled to the accessory coupling device 250, and the accessory coupling device 250 is coupled to the body 20.

As shown in FIG. 12, the first heat exchanger 320 and the first fan 330 are provided outside of the housing 302. In particular, the first heat exchanger 320 and the first fan 330 are positioned within a heat exchanger housing 700. The heat exchanger housing 700 defines an outlet 702. The first fan 330 is configured to provide the cooled airstream through the outlet 702 and towards the operator of the vehicle 10. The pump 340 is coupled to the first heat exchanger 320 via a conduit, shown as coolant line 710. The coolant line 710 may include a supply side that is configured to facilitate providing the coolant form the pump 340 to the first heat exchanger 320 and a return side that is configured to facilitate providing the coolant from the first heat exchanger 320 to the housing 302. In an example embodiment, the supply side of the coolant line 710 has a first end that is coupled to the pump 340, within the housing 302, and a second end that is coupled to the first heat exchanger 320, outside of the housing 302. In another example embodiment, the return side of the coolant line 710 has a first end that is coupled to the first heat exchanger 320, outside of the housing 302, and a second end that is positioned within the housing 302.

In the embodiment shown in FIG. 12, the heat exchanger housing 700 is coupled to the body 20 rearward of the front row seating 32. In other embodiments, the heat exchanger housing 700 is coupled to the body 20 at a different location. In any of the above-described embodiments, the heat exchanger housing 700 is positioned such that the first fan 330 is positioned to provide the cooled airflow to an operator of the vehicle 10. In some embodiments, the heat exchanger housing 700 is positioned such that the first fan 330 is positioned to provide the cooled airflow directly to the operator of the vehicle 10. In other embodiments, the heat exchanger housing 700 is positioned such that the first fan 330 is positioned to provide the cooled airflow indirectly to the operator of the vehicle 10, such as via one or more conduits or ducting (e.g., similar to the hose 500 and/or the ducting 600 coupled to the outlet 702).

As shown in FIG. 13, the vehicle 10 includes a fifth configuration of the golf vehicle accessory 300. The golf vehicle accessory 300 is at least partially positioned within the accessory storage device 220. For example, at least a portion of the lower housing portion 306 is positioned within the accessory storage device 220.

As shown in FIG. 13, the golf vehicle accessory 300 includes a tube (e.g., a conduit, etc.), shown as ducting 800. The ducting 800 has a first end 802 positioned to receive the air from the first fan 330. The ducting 800 is configured to split the received air into a first portion and a second portion. The ducting 800 has a second end 804 positioned to provide the first portion of the air at a location away from the first end 802 and a third end 806 positioned to provide the second portion of the air at a location away from the first end 802 and away from the second end 804. As shown in FIG. 13, the second end 804 is positioned proximate the front row seating 32. More specifically, the second end 804 is positioned proximate the first seat of the front row seating 32. The second end 804 of the ducting 800 may be selectively repositionable. For example, an operator may manipulate the ducting 800 to adjust a position of the second end 804. As shown in FIG. 13, the third end 806 is positioned proximate the front row seating 32. More specifically, the third end 806 is positioned proximate the second seat of the front row seating 32. The third end 806 of the ducting 800 may be selectively repositionable. For example, an operator may manipulate the ducting 800 to adjust a position of the third end 806. In some embodiments, the ducting 800 is supported by the first frame member 260 and/or the second frame member 262. In an example embodiment, the ducting 800 is coupled to the first frame member 260 and/or the second frame member 262. In another example embodiment, the ducting 800 is at least partially positioned within the first frame member 260 and/or the second frame member 262.

As shown in FIG. 14, the vehicle 10 includes a sixth configuration of the golf vehicle accessory 300. The golf vehicle accessory 300 is at least partially positioned within the accessory storage device 220. For example, at least a portion of the lower housing portion 306 is positioned within the accessory storage device 220.

As shown in FIG. 14, the first heat exchanger 320 and the first fan 330 are provided outside of the housing 302. In particular, the first heat exchanger 320 and the first fan 330 are positioned within a first heat exchanger housing 900. The first heat exchanger housing 900 defines a first opening 902. The first fan 330 is configured to provide the cooled airstream through the first opening 902 and towards the operator of the vehicle 10. The pump 340 is coupled to the first heat exchanger 320 via a conduit, shown as first coolant line 904. The first coolant line 904 may include a supply side that is configured to facilitate providing the coolant form the pump 340 to the first heat exchanger 320 and a return side that is configured to facilitate providing the coolant from the first heat exchanger 320 to the housing 302. In an example embodiment, the supply side of the first coolant line 904 has a first end that is coupled to the pump 340, within the housing 302, and a second end that is coupled to the first heat exchanger 320, outside of the housing 302. In another example embodiment, the return side of the first coolant line 904 has a first end that is coupled to the heat exchanger 320, outside of the housing 302, and a second end that is positioned within the housing 302.

In the embodiment shown in FIG. 14, the first heat exchanger housing 900 is coupled to the canopy 264 substantially rearward of the front row seating 32 and substantially vertically below the canopy 264. The first heat exchanger housing 900 is positioned such that the first fan 330 is positioned to provide the cooled airflow to an operator of the vehicle 10. In some embodiments, the first heat exchanger housing 900 is positioned such that the first fan 330 is positioned to provide the cooled airflow directly to the operator of the vehicle 10. In other embodiments, the first heat exchanger housing 900 is positioned such that the first fan 330 is positioned to provide the cooled airflow indirectly to the operator of the vehicle 10, such as via one or more hoses (e.g., similar to the hose 500 and/or the ducting 600).

As shown in FIG. 14, the second heat exchanger 322 and the second fan 332 are provided outside of the housing 302. In particular, the second heat exchanger 322 and the second fan 332 are positioned within a second heat exchanger housing 910. The second heat exchanger housing 910 defines a second opening 912. The second fan 332 is configured to provide the cooled airstream through the second opening 912 and towards the operator of the vehicle 10. The pump 340 is coupled to the second heat exchanger 322 via a conduit, shown as second coolant line 914. The second coolant line 914 may include a supply side that is configured to facilitate providing the coolant form the pump 340 to the second heat exchanger 322 and a return side that is configured to facilitate providing the coolant from the second heat exchanger 322 to the housing 302. In an example embodiment, the supply side of the second coolant line 914 has a first end that is coupled to the pump 340, within the housing 302, and a second end that is coupled to the second heat exchanger 322, outside of the housing 302. In another example embodiment, the return side of the second coolant line 914 has a first end that is coupled to the second heat exchanger 322, outside of the housing 302, and a second end that is positioned within the housing 302.

In the embodiment shown in FIG. 14, the second heat exchanger housing 910 is coupled to the canopy 264 substantially rearward of the front row seating 32 and substantially vertically below the canopy 264. The second heat exchanger housing 910 is positioned such that the second fan 332 is positioned to provide the cooled airflow to an operator of the vehicle 10. In some embodiments, the second heat exchanger housing 910 is positioned such that the second fan 332 is positioned to provide the cooled airflow directly to the operator of the vehicle 10. In other embodiments, the second heat exchanger housing 910 is positioned such that the second fan 332 is positioned to provide the cooled airflow indirectly to the operator of the vehicle 10, such as via one or more hoses (e.g., similar to the hose 500 and/or the ducting 600).

While the golf vehicle accessory 300 has been described herein as providing cooled air directly to the occupants within the occupant seating area 30, in some embodiments when the occupant seating area 30 is fully enclosed, the golf vehicle accessory 300 can be configured to provide the cooled air into the enclosure, rather than directly to the occupants. In such embodiments, the golf vehicle accessory 300 may include only one fan and/or heat exchanger.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the golf vehicle accessory 300 as shown in the various exemplary embodiments is illustrative only. Additionally, any element disclosed in one embodiment may be incorporated or utilized with any other embodiment disclosed herein.

1. A golf vehicle comprising:
a frame;
a seat coupled to the frame, the seat configured to support an operator;
a cooling assembly including:
a housing defining a housing volume configured to receive a coolant;
a heat exchanger;
a fan proximate the heat exchanger, the fan configured to selectively provide air through the heat exchanger to facilitate providing a cooled airflow to the operator, the fan operable between a first fan state and a second fan state; and
a pump positioned within the housing volume, the pump fluidly coupled to the heat exchanger, the pump configured to selectively provide the coolant to the heat exchanger, the pump operable between a first pump state and a second pump state; and
a sensor coupled to the cooling assembly, the sensor configured to detect a presence of the operator;
wherein the sensor provides a first signal when the presence of the operator is not detected that causes the fan to operate at the first fan state and the pump to operate at the first pump state; and
wherein the sensor provide a second signal when the presence of the operator is detected that causes the fan to operate at the second fan state and the pump to operate at the second pump state.

2. The golf vehicle of claim 1, further comprising an accessory storage area positioned rearward of the seat, wherein the cooling assembly is at least partially positioned within the accessory storage area.

3. The golf vehicle of claim 1, further comprising a compartment positioned underneath the seat, wherein the cooling assembly is at least partially positioned within the compartment.

4. The golf vehicle of claim 1, wherein the cooling assembly includes a hose having a first end positioned to receive the air from the fan and a second end positioned to provide the air at a location away from the first end.

5. The golf vehicle of claim 4, wherein the second end of the hose is selectively repositionable.

6. The golf vehicle of claim 1, wherein the fan is configured to provide the air through the heat exchanger and toward the operator when the fan is operating in the second fan state.

7. The golf vehicle of claim 1, wherein the pump is configured to provide the coolant to the heat exchanger when the pump is operating in the second pump state.

8. The golf vehicle of claim 1, wherein the sensor is coupled to the seat and biased to a first sensor position such that the sensor is in the first sensor position when the seat is unoccupied and a second sensor position when the seat is occupied, wherein the first fan state and the first pump state are off states.

9. The golf vehicle of claim 1, wherein the housing includes:
a lower housing portion defining the housing volume; and
an upper housing portion supported by the lower housing portion, the upper housing portion defining an opening, wherein at least one of the heat exchanger or the fan is disposed within the upper housing portion, and wherein the air flows through the opening.

10. The golf vehicle of claim 9, wherein the fan and the heat exchanger are disposed within the upper housing portion.

11. The golf vehicle of claim 1, wherein the coolant comprises a mixture of water and ice.

12. The golf vehicle of claim 1, further comprising a headrest assembly coupled to the cooling assembly and positioned proximate the seat, the headrest assembly including:
a head support defining an opening, wherein the fan is configured to provide the air through the opening; and
a cover wrapped around the head support, wherein the cover comprises a fabric material;
wherein the cooling assembly is positioned such that a top surface of the cooling assembly is at or below a horizontal plane defined by a top of the headrest assembly.

13. The golf vehicle of claim 1, wherein the fan is a first fan, the air is first air, the cooled airflow is first cooled airflow, and the heat exchanger is a first heat exchanger, and wherein the cooling assembly includes:
a second heat exchanger spaced laterally away from the first heat exchanger, wherein the pump is configured to selectively provide the coolant to the second heat exchanger; and
a second fan proximate the second heat exchanger, the second fan configured to selectively provide second air through the second heat exchanger to facilitate providing a second cooled airflow to an occupant of the golf vehicle.

14. The golf vehicle of claim 1, wherein the sensor includes at least one of a seat switch, a floor switch, a proximity sensor, a camera, or a weight sensor.

15. The golf vehicle of claim 1, further comprising a switch coupled to the pump and the fan, the switch selectively positionable between a first switch position and a second switch position, wherein the switch prevents the fan from operating at the second fan state and prevents the pump from operating at the second pump state when the switch is in the first switch position, and wherein the switch allows the fan to operate at the second fan state and allows the pump to operate at the second pump state when the switch is in the second switch position and the sensor provides the second signal.

16. The golf vehicle of claim 1, wherein the housing includes an outlet port in fluid communication with the housing volume configured to facilitate draining the coolant therefrom.

17. The golf vehicle of claim 1, wherein the housing is positioned rearward of the seat.

18. The golf vehicle of claim 1, wherein the housing is positioned underneath the seat.

19. A cooling assembly for a vehicle, the cooling assembly comprising:
a housing defining an opening and a housing volume configured to receive a coolant;
a heat exchanger;
a fan proximate the heat exchanger, the fan configured to selectively provide air through the heat exchanger and the opening to facilitate providing a cooled airflow to an operator of the vehicle;
a pump positioned within the housing volume, the pump fluidly coupled to the heat exchanger, the pump configured to selectively provide the coolant to the heat exchanger; and
a sensor configured to detect a presence of the operator;
wherein the sensor provides a signal when the presence of the operator is detected that causes the fan and the pump to operate.

20. A golf vehicle comprising:
a frame;
a seat coupled to the frame, the seat configured to support an operator;
a sensor configured to detect a presence of the operator;
an accessory storage area positioned proximate the seat; and
a golf vehicle accessory including:
an upper housing portion;
a lower housing portion defining a housing volume configured to receive a coolant, the lower housing portion positioned least partially within the accessory storage area;
a heat exchanger positioned within the upper housing portion;
a fan proximate the heat exchanger, the fan configured to selectively provide air through the heat exchanger to facilitate providing a cooled air flow to the operator; and
a pump positioned within the housing volume, the pump fluidly coupled to the heat exchanger, the pump configured to selectively provide the coolant to the heat exchanger;
wherein the sensor provides a signal when the presence of the operator is detected that causes the fan and the pump to operate.
